(19) United States
(12) Patent Application Publication
(10) Pub. No.: US 2013/0136601 A1
(43) Pub. Date: May 30, 2013

(54) Large Contra-Rotating Wind Turbine

(71) Applicant: Robert Stephen Watral, (US)

(72) Inventor: Robert Stephen Watral, (US)

(21) Appl. No.: 13/304,440

(22) Filed: Nov. 25, 2011

(51) Int. Cl. F03D 1/02; F03D 11/02

(52) U.S. Cl. 416/128; 416/223 R

(57) ABSTRACT

Large Contra-Rotating Wind Turbine used to generate mechanical torque by extracting wind energy efficiently. Large scale innovative rotor designs include swept blades to utilize a tension hoop, which supports the outside end of the blades instead of having cantilevered rotor blades. Actual size and configuration of the rotors or blades, including swept area, number of blades, curvature of blades, airfoil shape, or other bends of the blades are not relevant or specific to this invention, however this innovation does allow the size and capacity of the wind turbine to achieve capacities of 3.0 Mw or greater. This new wind turbine configuration places the electric generator at grade where it is easy to access and maintain, and is not supported by the tower. The capacity of this new wind turbine configuration type can be larger than 3.0 Mw.

### A. CROSS-REFERENCE TO RELATED APPLICATIONS

“Not Applicable”

### B. STATEMENT REGARDING FEDERALLY SPONSORED RESEARCH OR DEVELOPMENT

“Not Applicable”

### C. THE NAMES OF THE PARTIES TO A JOINT RESEARCH AGREEMENT

“Not Applicable”

### D. INCORPORATION-BY-REFERENCE OF MATERIAL SUBMITTED ON A COMPACT DISC

“Not Applicable”

### E. BACKGROUND OF THE INVENTION

1. Field of the Invention

This invention relates to the efficient conversion of “clean, renewable” wind energy to mechanical energy for subsequent generation of electricity on a commercially significant scale.

2. Description of Related Art

Developing renewable energy resources has become a very high priority in recent years due to the limited availability of future oil supplies, and concerns for global warming. Many States, and the Federal government have implemented short-term incentives to develop wind generated electricity, with the stated goal to have ˜20% of the power generated in the U.S. by wind power. Cost-effective wind farms are totally dependent on the available wind energy, and therefore are severely limited to a few sites that are capable of supporting cost-effective wind power. Therefore it is essential that the wind turbines installed extract as much usable energy from the limited number of viable sites. The current 3-blade wind turbines typically extract less than 20% of the available power based on a ˜6% solidity compared to the optimum 33% solidity. So about 80% of this limited energy resource is not used by each typical 3-blade wind turbine installation because the focus has been on “aerodynamic efficiency” instead of “absolute efficiency”.

There are only two previous patents that seem typical of the prior art attempting to use two contra rotating rotors effectively. U.S. Pat. No. 6,278,197 is titled “Contra-rotating wind turbine system”, however, it seems that a more accurate title could have been “Contra-rotating wind turbine-generator”, which is also what U.S. Pat. No. 6,504,260 could have been titled. Both of these previous patents have devices that only have one axis, or a “co-axial shaft”, and both devices actually generate electricity and could accurately be called “small wind-powered generators”. The scale of the previous patents is much smaller than the capability of the present device, which is designed to extract in the range of 10 Kw to 3.0 Mw or more of power, which is as large as some of the largest current 3-blade wind turbines. This device requires two individual shafts to support the weight and large forces developed by the large capacity rotors, and a gearbox to combine the power from the two shafts into one drive shaft that transmits the power to the electric generator at ground level. The significant differences with the prior art can be summarized as the prior devices both generate electricity, but both have a “co-axial shaft”, and both are relatively small in scale. The innovations of this device include the large size, using two contra-rotating rotors, using a gearbox to support the rotors, and to place the generator at ground level. The actual configuration of the rotors which need to be strong enough to withstand hurricane force winds, yet light enough and effective enough to rotate efficiently can vary as to size and type. The rotors can both be high-torque “impingement” type, both “airfoil” type, or a combination. The key requirement is that the front rotor needs to be stiff enough to clear the tower as it rotates. Current 3-blade rotors generally deflect or flex so much that the blades would impact the tower if used with this patent's configuration. The current innovations include a stiffer rotor, optimum solidity, contra-rotation, and the location of the generator at ground level facilitating maintenance. An additional efficiency is that the large and heavy nacelle is not needed, and is replaced by the gearbox. Further, the back rotor (second rotor) can deflect significantly without interfering with the tower. This invention endeavors to use the “optimum” solidity and the “optimum” rotational velocity to maximize efficiencies and provide a large scale cost-effective alternative to 3-blade wind turbines, to extract the most energy per installation. In other words, this invention can extract more energy using 10-18 blades (for example) on one tower than the typical 3-blade wind-turbine.

It is with the understanding of the prior art, and the energy needs of the future that the present invention was developed and is now presented.

### F. BRIEF SUMMARY OF THE INVENTION

The invention is comprised of two large multi-blade rotors that use wind power that impinges on the blades of the front rotor to spin the front rotor. The “solidity” of the two rotors is designed to be closer to 33%, which is the optimum ratio of blade area to total swept area according to the Betz Law. The options provided by this device is that the airflow that impinges on the front set of blades may be deflected somewhat to the blades of the rear rotor, which spins via contra-rotation (the opposite direction) as the front rotor, or the blades can be designed not to affect each other. Both the front and rear blades will be designed to maximize the wind energy transfer based on the site specific conditions. The downstream airflow, exiting the second rotor is swept away by the surrounding airflow, i.e. the wind turbine is not a closed system, or a “control volume”, but a small area in a large mass of moving air that constantly changes velocity and direction. The torque from both rotors is transmitted via two individual shafts to one gearbox, which re-directs the torque to a vertical shaft, which transmits the torque down the tower to a generator at ground level. This arrangement keeps the rotors clear of the tower, balances both rotors on the gearbox, and puts the generator and most of the high maintenance items on ground level where they can be accessed much more efficiently. To be installed and operated the invention needs many of the same components as the typical large scale 3-blade units, such as automated “yaw control” which spins the rotors about the vertical axis to keep the rotors facing into the wind, as well as lightning protection, grounding, a control system, lights, sound proofing, metering, bird kill avoidance system, etc. The innovations claimed include the overall configuration including two rotors, more than 3-blades per rotor, contra-rotating gearbox, the generator location at grade, the design of the large scale rotors, including the structural innovations such as the tension hoop stiffener, a slight curve to the blades to reduce the vibration (pulsing) caused by the (narrower) tower. The number of blades per rotor and exact shape of blades are not claims, as they are site specific.

### G. BRIEF DESCRIPTION OF THE SEVERAL VIEWS OF THE DRAWINGS

FIG. 1

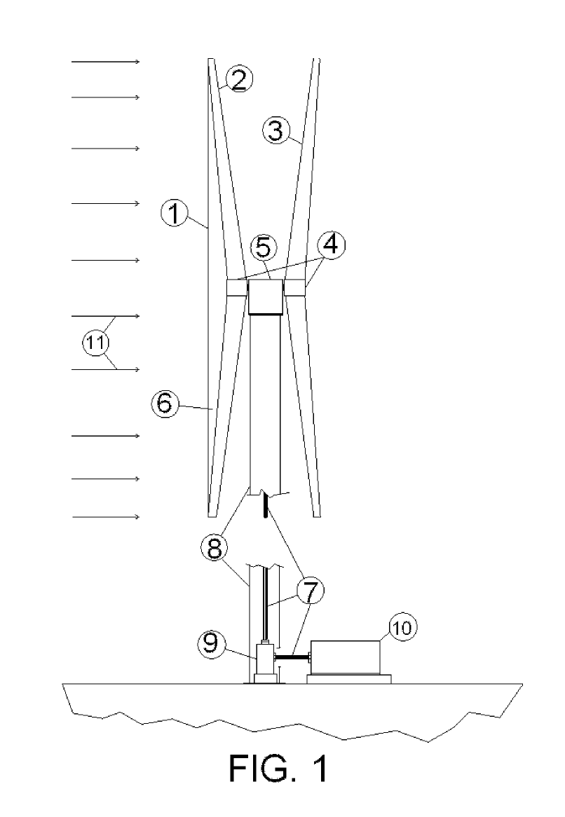

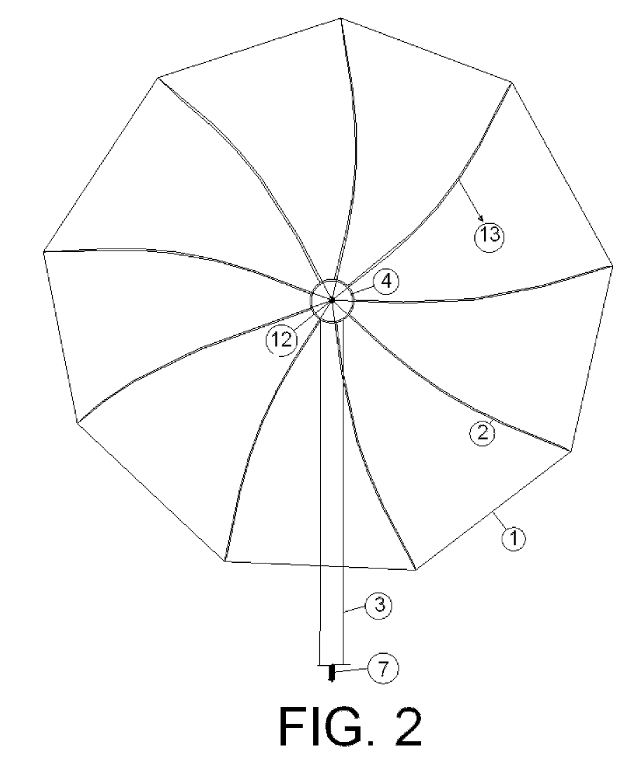

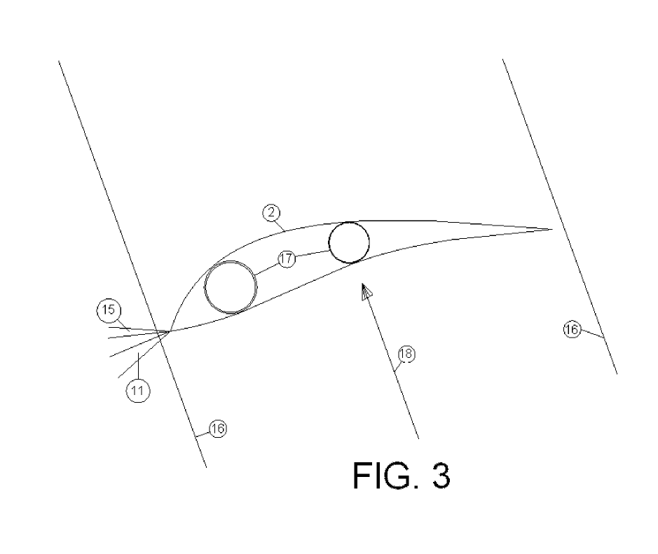

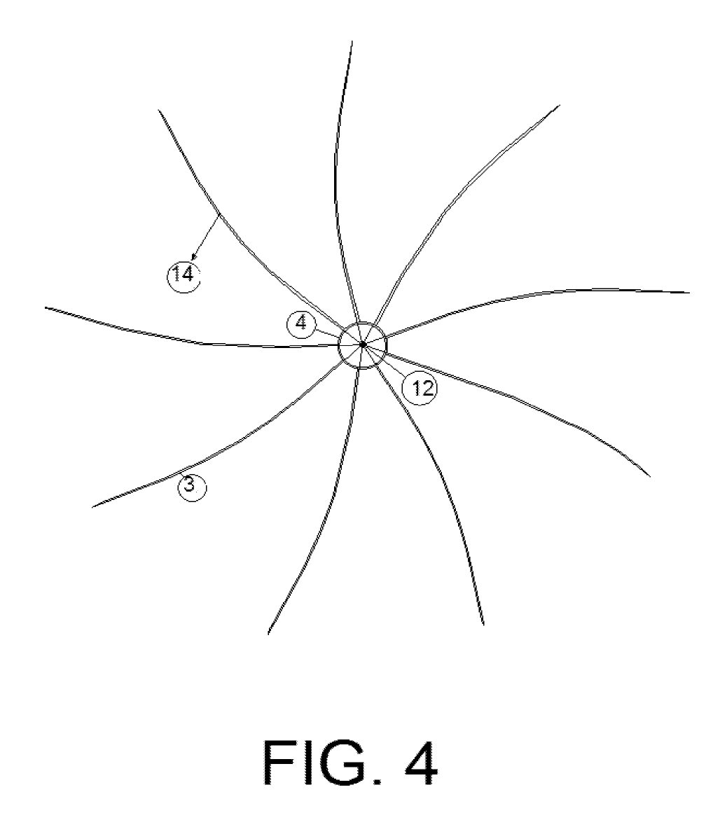

Side View:

This view shows the uniqueness of the invention, showing two rotors on one tower. The front rotor blades 2 are swept slightly forward (angular offset 6) to allow the use of a structural tension hoop 1 at the outer edge of the front rotor blades 2 to convert the wind force 11 to internal tension thereby reducing the cantilever moments of the front rotor blades 2. This tension hoop 1 reduces the amount of structural metal needed, and thereby reduces the rotational inertia of the front rotor, optimizing efficiency. Also seen is the arrangement and spacing of the front rotor blades 2 and rear rotor blades 3 balancing on the gearbox 5, and the output shaft 7 going down the tower 8, to a right-angle gear 9, to a commercially available generator 10 at ground level, which generates electricity. The generator is expected to be housed inside a structure (not shown) to protect it from the weather and to provide sound-proofing and easy maintenance access. The rotor hubs 4 are seen at the center of each rotor and connect the individual blades of the rotors to the gearbox via offset shafts. A finite element analysis of the front rotor shows that the tension hoop 1 can develop a tension force of 50,000 pounds, but reduces the moments in the blades 2 significantly, allowing more blades per hub. During operation the gearbox will rotate about the vertical axis, the same way the “Nacelle” of existing wind turbines spins to keep the rotors facing into the wind.

FIG. 2

Front View:

This view shows the major difference with standard 3-blade turbines. The design intent is to improve the “solidity” to be closer to the optimum 33%. Nine airfoil type rotor blades 2 are shown for the front rotor, however, rotors may be comprised of any number of blades, which will vary depending upon power of the generator, the design radii of the rotors, and the design wind velocity of each specific site. Also variable is the shape and contour of the rotor blades. The rotor blades 2 are fastened to the rotor hub 4, and the rotor hub is connected to the gearbox via the gearbox shaft 12. The gearbox (not seen in FIG. 2) redirects the shaft energy down the tower 3 via the drive shaft 7. In the configuration shown, the front rotor is rotating clockwise 13.

FIG. 3

Airfoil Detail:

This detail shows one possible rotor blade 2 profile, and some of the possible design details needed to fabricate the “airfoil” type rotor blade 2. Note that the actual configuration of any rotor blade design varies according to site specific conditions, such as average wind velocity. This “airfoil type” rotor blade example has a lift coefficient of 1.8 and a drag coefficient of 0.03 and the two pipe sections 17 shown are an example of how the airfoil blade may be designed to fasten to the rotor hub (not shown). The rotation direction 18 of rotor blade 2 is shown rotating upward in this view, within the hypothetical rotational boundary lines 16. The working wind direction zone 11 to provide “lift”, and the “stall zone” 15 are shown. The rotor and blade configuration would need to be designed using a CFD (Computational Fluid Dynamics) analysis for the specific site, and specific size and type of generator.

FIG. 4

Rear Rotor Detail:

This detail shows one possible rear rotor configuration, including the rotor blades 3, the rotor hub 4, the gearbox shaft 12, and the direction of rotation 14 (counter-clockwise).

### H. DETAILED DESCRIPTION OF THE INVENTION

1. The unit starts by constructing a tower foundation and possibly tower brace foundations, sized per site conditions. The two rotors may mean that the lateral wind force developed would require that the tower could need to be braced against overturning.
2. The tower is fastened to the foundation, the height and shape of the tower varies per site conditions, as well as the size and weight of the rotors, which determines the lateral thrust developed by design wind conditions.
3. On top of the tower the yaw control system is fastened. The yaw control system is generally comprised of thrust bearings, and several electric motors and gearing sized to rotate the gearbox and rotors about the vertical axis of the tower to keep the blades facing into the wind. This system can be similar to those currently used successfully by 3-blade wind turbines.
4. The gearbox is comprised of three main shafts, one for the front rotor, one for the rear rotor, spinning in the opposite direction, and the vertical output shaft out the bottom of the gearbox. The gear ratio and actual design of the gearbox will be site specific, dependant upon the site specific size and type of generator used.
5. The gearbox shafts extend outward to fasten and support the rotor hubs. The rotor hubs are fastened to the shaft via keyways and bolts.
6. The rotor hubs are designed to have blade stubs or some other structural attachment designed to fasten the individual rotor blades. The actual size and arrangement of the rotor hubs is site specific as to the number and type of rotor blades fastened. The gearbox, shafts, and hubs may be designed with the rotors offset rotationally a few degrees to avoid tower interference with airflow and excess rotor vibration/wobble/pulsing (same rationale' as why current rotors have 3-blades and not 4-blades). The front hub needs to sweep the front rotor slightly forward, and the back hub sweeps the back rotor slightly backward to avoid interference with the tower. The exact number of degrees of forward sweep and the rotational offset of the rotors is site specific.
7. The individual blades are then fastened to the hub via bolts. The blades are generally comprised of a structural beam-stem, and a shaped plate (curved or airfoil shaped) to provide wind impingement area. The plate may be flat, curved, or bent locally to maximize the rotational force. At the end of the blade is a structural detail to fasten a tension hoop to support the blade end to minimize blade deflection.
8. As the wind turns the rotors, which turn the hubs/shafts, the gearbox turns a vertical shaft that exits the bottom of the gearbox, goes down the inside of the tower to a right-angle gear (or generator) at the bottom of the tower. From there the shaft powers a generator in an enclosure at grade. The power generated is then connected to the local utility grid, or is used by an end user. The type and size of generator is site/job specific.
9. There may be other items required to permit the construction at any specific site, such as airplane warning lights, lightning protection, bird warning system, grounding, sound proofing, tower braces, safety paint, pile foundations, corrosion protection, de-icing system, etc. However, these appurtenances do not affect the basic operation of the wind turbine, and are the same as used generally.

1. Swept rotor blades (front rotor blades swept forward) in order to use a tension hoop, such that the hoop stress developed supports the rotor blade ends and reduces the forces and moments that would be developed if the blades were cantilevered. These innovations makes the rotor blades small enough and light enough to clear the tower and allows the practical design of large capacity contra-rotational wind turbines.

2. New configuration for wind turbines, with two large contra-rotating rotors, a gearbox with a vertical output shaft, with the generator located at grade, this new arrangement provides a much more efficient layout for generator maintenance, and reduces the size and weight of the “nacelle” components supported by the tower.

3. Two large multi-blade contra-rotating rotors with individual shafts, of sufficient size to provide a wind turbine with 10 Kw to 3.0 Mw or more of power generation. This claim is independent of the number of blades per rotor, or the length/type/shape of the blades.

4. Slightly curved or angled blades to minimize “pulsing” caused by the effect of the tower on the airflow. This innovation significantly reduces the “pulsing” or “wobble” typically thought to limit the number of blades to three. By increasing the number of blades on a tower from three to a larger number, the economic viability of a wind power site improves and allows the solidity to improve from the current approximately 6% much closer to the theoretical optimum of 33%. (currently the force on a straight blade is affected as it passes by the tower, causing the rotor to wobble, this innovation minimizes this effect)
